(19) United States
(12) Patent Application Publication
(10) Pub. No.: US 2016/0210668 A1
(43) Pub. Date: Jul. 21, 2016

(54) System, Device, and Method for Executing Function of Application Based on Advertisement

(71) Applicant: Samsung Electronics Co., Ltd., Suwon-si (KR)

(72) Inventor: Ho-Ryong JUNG, Suwon-si (KR)

(21) Appl. No.: 15/000,007

(22) Filed: Jan. 18, 2016

(30) Foreign Application Priority Data
Jan. 16, 2015 (KR) 10-2015-0007940

(51) Int. Cl. G06Q 30/02; H04L 29/08

(52) U.S. Cl. CPC G06Q 30/0258; H04L 67/34

(57) ABSTRACT

The present disclosure relates to a system, a device, and a method for executing a function of an application based on an advertisement of the application. A system for executing a function of an application based on an advertisement includes a server that provides advertisement contents containing a script for an advertisement, and transmits data associated with an application when the registration of the application associated with script information collected by the script for the advertisement is confirmed, and an electronic device that collects the script information according to a user input for the advertisement contents and transmits the collected script information to the server, receives data associated with the application, and executes a function of the application according to the data.

### RELATED APPLICATION(S)

This application claims the priority under 35 U.S.C. §119(a) to Korean Application Serial No. 10-2015-0007940, which was filed in the Korean Intellectual Property Office on Jan. 16, 2015, the entire content of which is hereby incorporated by reference.

### BACKGROUND

The present disclosure relates to the execution of a function by an electronic device, and more particularly, to a system, a device, and a method for executing a function related to an application based on an advertisement of an application.

An advertisement for a product, such as a software (SW) application, may not have a link with a server of a store that sells the advertised product. That is, a system may collect information through the advertisement about interest in the product, but the information is not associated directly with the store selling the advertised product. Accordingly, in spite of advertisements that may be shown before the release of an application, it is impossible to buy or install the application before its release even if the application attracts great interest from potential users. It may be difficult, therefore, to maintain the interest of a user until actual release of the application. Furthermore, if the user does not frequently check for information on the release of the application, the user may miss buying the application when the application is released.

An advertisement of an application provides information about the corresponding application. However, since there is no associative relationship between the advertisement and a server that will actually sell the application, a user's interest in the advertised application may not influence the purchase or installation of that application at a later time.

### SUMMARY

The present disclosure may provide a device and a method for setting up in advance, during an advertising stage before an application is released, future execution of a function associated with the application.

The present disclosure may provide a device and a method for executing a function associated with an application based on information about the application available at that time.

An exemplary embodiment of the present disclosure provides a method that includes displaying on an electronic device advertisement for an application, detecting at least one user input in response to the advertisement, collecting script information according to execution of a script included as part of contents of the advertisement, wherein the script information comprises at least one user input, receiving data associated with the application, wherein a function to be executed is part of the data, and executing the function.

An exemplary embodiment of the present disclosure provides a method that includes displaying on an electronic device advertisement contents, detecting at least one user input in response to the advertisement contents, executing a script included in the advertisement contents based on the user input, collecting script information according to the executed script, receiving data associated with a registration of at least one application including a function corresponding to the script information, and executing the function associated with the application based on the data.

Another exemplary embodiment of the present disclosure provides an electronic device that includes a display configured to display advertisement for an application and a processor. The process may be configured to detect at least one user input in response to the advertisement, to collect script information according to execution of a script included as part of contents of the advertisement, wherein the script information comprises at least one user input, to receive data associated with the application, wherein a function to be executed is part of the data, and to execute the function.

Another exemplary embodiment of the present disclosure provides an electronic device that includes a display configured to display advertisement contents, and a processor configured to detect at least one user input in response to the advertisement contents, to execute a script included in the advertisement contents based on the user input, to collect script information according to the executed script, to receive data associated with a registration of at least one application including a function corresponding to the script information, and to execute the function associated with the application based on the data.

Yet another exemplary embodiment of the present disclosure provides a server that includes a sales unit configured to produce an application and advertisement contents for the application; an advertisement providing unit configured to provide the advertisement contents containing a script for an advertisement; and a store unit configured to receive script information collected by the script for the advertisement, register the application produced by the sales unit, and transmit data associated with the registration of the application to an electronic device according to the registration of the application.

According to a method of executing a function for an application based on an advertisement according to an exemplary embodiment of the present disclosure, a user may set up for execution of a function related to an application during an advertising stage of the application before the release of the application, and when the corresponding product is later released, the function may be automatically executed. Accordingly, the probability of purchase at the time of the release of the product may be increased from the advertising stage before the release of the product, thereby improving the effectiveness of the advertisement. Further, the user may conveniently receive information about a product of interest and may buy the product of interest.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a schematic diagram of a system for executing a function of an application based on an advertisement according to an exemplary embodiment of the present disclosure;

FIG. 2 is a data flow diagram describing a method of executing a function of an application based on an advertisement according to an exemplary embodiment of the present disclosure;

FIG. 3 is a block diagram illustrating an electronic device according to an exemplary embodiment of the present disclosure;

FIG. 4 is a detailed block diagram illustrating an electronic device according to an exemplary embodiment of the present disclosure;

FIG. 5 is a block diagram illustrating a program module according to various exemplary embodiments of the present disclosure;

FIG. 6 is a flow chart describing a method of selecting the execution a function associated with a registration of an application according to an exemplary embodiment of the present disclosure;

FIGS. 7 to 10 are flow charts for describing a method of executing a function of a user electronic device associated with the registration of an application according to an exemplary embodiment of the present disclosure;

FIG. 11 is a diagram describing a method of executing a function of an application based on an advertisement associated with an exemplary embodiment of the present disclosure; and

FIGS. 12 to 14 are diagrams describing a method of executing a function of an application based on an advertisement associated with an exemplary embodiment of the present disclosure.

### DETAILED DESCRIPTION

Hereinafter, the present disclosure will be disclosed with reference to the accompanying drawings. Since various changes may be made to the present disclosure and the present disclosure may have several embodiments, particular embodiments are illustrated in the drawings and related detailed descriptions will be provided. However, the present disclosure is not intended to limit the present disclosure to particular embodiments, and it should be construed as including various modifications, equivalents, and/or alternatives according to the embodiments of the present disclosure. In regard to the description of the drawings, like reference numerals refer to like elements.

As used herein, the expression “have,” “may have,” “include,” or “may include” refers to the existence of a corresponding feature (e.g., numeral, function, operation, or constituent element such as component), and does not exclude one or more additional features.

As used herein, the expression “A and/or B,” “at least one of A and/or B,” or “one or more of A and/or B” may include any or all possible combinations of items enumerated together. For example, the expression “A and/or B,” “at least one of A and B,” or “at least one of A or B” refers to all of (1) including at least one A, (2) including at least one B, or (3) including at least one A and at least one B.

Expressions such as “first,” “second,” “primary,” or “secondary,” used in descriptions of various exemplary embodiments may represent various elements regardless of order and/or importance and do not necessarily indicate relative importance of or specific order of corresponding elements. The expressions may be used for distinguishing one element from another element. For example, a first user device and a second user device may represent different user devices regardless of order or importance. For example, a first element may be referred to as a second element without deviating from the scope of the present disclosure, and similarly, a second element may be referred to as a first element.

When it is described that a first element is “operatively or communicatively coupled” or “connected” to a second element, the first element can be directly connected to the second element or it can be connected to the second element through a third element. However, when it is described that a first element is “directly connected” or “directly coupled” to a second element, it means that there is no intermediate element (such as a third element) between the first element and the second element.

The expression “configured to” used in the present disclosure may be replaced with, for example, “set to,” “suitable for,” “having the capacity to,” “designed to,” “adapted to,” “made to,” or “capable of” according to a situation. The expression “configured to” does not necessarily mean “specifically designed to” do a function by hardware. Alternatively, in some situation, an expression “apparatus configured to” may mean that the apparatus “can” operate together with another apparatus or component. For example, the phrase “a processor configured to perform A, B, and C” may refer to a generic-purpose processor (such as a central processing unit (CPU) or an application processor) that can perform a corresponding operation by executing at least one software program stored at a memory device or an exclusive processor (such as an embedded processor) for performing a corresponding operation.

Terms defined in the present disclosure are used for only describing a specific exemplary embodiment and may not have an intention of limiting the scope of other exemplary embodiments. When used in the present disclosure and the appended claims, a singular form may also encompass the plural form unless it is explicitly stated otherwise. All terms including technical terms and scientific terms used here may have the same meaning as generally understood by a person of common skill in the art. Terms defined in a dictionary have the same meaning as or a meaning similar to that of a context of related technology and should not be analyzed to have an ideal or excessively formal meaning unless explicitly defined as such. Terms defined in the present disclosure should not be analyzed to exclude the present exemplary embodiments.

An electronic device according to various embodiments of the present disclosure may be a device including a communication function. For example, the electronic device may include at least one of, for example, a smart phone, a tablet Personal Computer (tablet PC), a mobile phone, a video phone, an electronic book (e-book) reader, a desktop PC, a laptop PC, a netbook computer, a Personal Digital Assistant (PDA), a Portable Multimedia Player (PMP), an MP3 player, mobile medical equipment, a camera, and a wearable device (e.g., smart glasses, Head-Mounted Device (HMD), an electronic cloth, an electronic bracelet, an electronic necklace, an appcessory, an electronic tattoo, a smart mirror, or a smart watch).

According to some embodiments of the present disclosure, the electronic device may be a smart home appliance. The home appliance may include, for example, at least one of a Television (TV), a Digital Video Disk (DVD) player, audio equipment, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ or PlayStation™), an electronic dictionary, an electronic key, a camcorder, and an electronic frame.

According to another embodiment of the present disclosure, the electronic device may include at least one of various equipments such as, for example, a blood sugar measurement device, a heartbeat measurement device, a blood pressure measurement device, or a body temperature measurement device, Magnetic Resonance Angiography (MRA) device, Magnetic Resonance Imaging (MRI) device, Computed Tomography (CT) device, an imaging device, or an ultrasonic device, a navigation system, a Global Positioning System (GPS) receiver, an Event Data Recorder (EDR), a Flight Data Recorder (FDR), a vehicle infotainment device, electronic equipment for ships (e.g., navigation system and gyro compass for ships), avionics, a security device, a vehicle head unit, an industrial or home robot, an Automatic Teller Machine (ATM), a Point of Sales (POS), Internet of Things (IoT) (e.g., electric bulbs, various sensors, electricity or gas meters, sprinkler devices, fire alarm devices, thermostats, streetlights, toasters, exercise machines, hot-water tanks, heaters, boilers, etc.).

According to some embodiments of the present disclosure, the electronic device may include a part of furniture or building/structure, an electronic board, an electronic signature receiving device, a projector, and various measuring instruments (e.g., a water, electricity, gas, or electric wave measuring device). The electronic device according to various embodiments of the present disclosure may be one of the above-listed devices or a combination thereof. The electronic device according to various embodiments of the present disclosure may be a flexible device. It will be obvious to those of ordinary skill in the art that the electronic device according to various embodiments of the present disclosure is not limited to the above-listed devices and may include new electronic devices according to technical development.

Hereinafter, an electronic device according to various embodiments of the present disclosure will be described with reference to the accompanying drawings. Herein, the term “user” may refer to a person who uses the electronic device or a device using the electronic device (e.g., an artificial intelligence electronic device).

Hereinafter, a method will be described for making arrangements in advance to execute a function related to an application at a later time. The arrangements may be made by selecting options in an advertisement about the application, where the function will execute at the application release date according to various embodiments of the present disclosure.

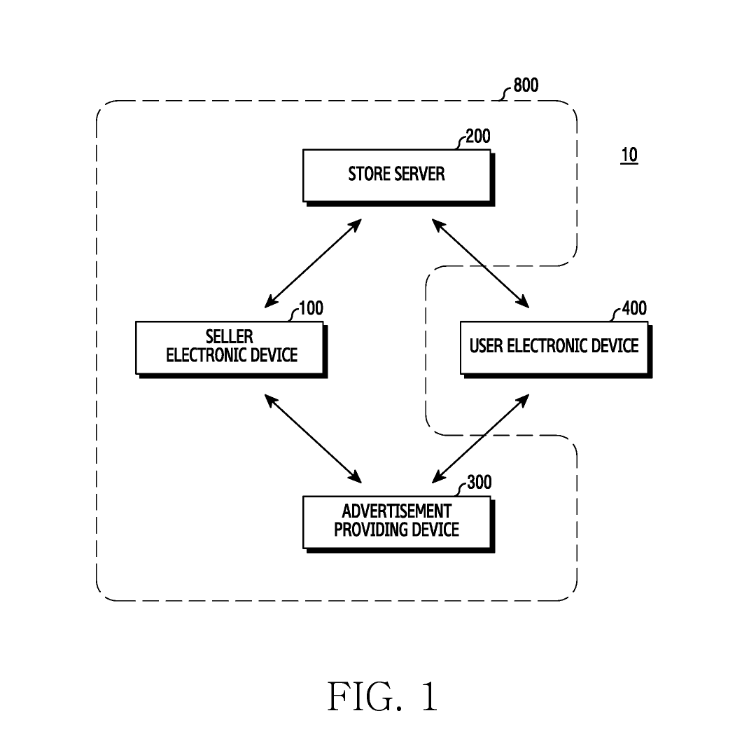

FIG. 1 is a schematic diagram of a system for executing a function of an application based on an advertisement according to an exemplary embodiment of the present disclosure.

Referring to FIG. 1, a system 10 for executing a function of an application related to an advertisement may include a seller electronic device 100, a store server 200, an advertisement providing device 300, and a user electronic device 400.

The seller electronic device 100, the store server 200, and the advertisement providing device 300 may be collectively called a server 800. The seller electronic device 100 may produce applications and advertisement contents about the applications, and provide advertisement contents containing a script for advertisements. The store server 200 may receive script information collected by the script for advertisement, register the application produced by the sales unit, and transmit data associated with a registration of the application according to the registration of the application to an electronic device. The advertisement providing device 300 may post the advertisement contents transmitted from the seller electronic device 100 through a medium such as the Internet. The advertisement contents may be provided to the user electronic device 400 through a banner advertisement, a web page, and the like.

According to various examples of the present disclosure, in the system 10 for executing a function of an application based on an advertisement, at least one of the aforementioned elements may be omitted or another element may be additionally included.

The seller electronic device 100 is a main agent that produces an application and registers the produced application in the store server 200 and releases the produced application. The seller electronic device 100 generates meta data about an application to be produced and registers the generated meta data in the store server 200. The meta data may include a name of an application, a package name (unique ID) of an application, a project name, a producing company name, the kind of application, and the like. The seller electronic device 100 receives a script for an advertisement from the store server 200 in response to the registration of the meta data, produces advertisement contents containing the script for the advertisement, and transmits the produced advertisement contents to the advertisement providing device 300.

The store server 200 is a server connected with a store client. The store client is a store application used for installing a new application at the user electronic device 400. The store server 200 receives an application from the seller electronic device 100 and sells the received application.

The store server 200 registers the meta data received from the seller electronic device 100, and issues the script for the advertisement to the seller electronic device 100. Then, the store server 200 receives script information collected by the script for the advertisement from the user electronic device 400 and stores the received script information. When the application is registered by the seller electronic device 100, the store server 200 transmits data associated with the registration of the application to the user electronic device 400 based on the script information.

The script for the advertisement may be implemented by a programming language that is interpreted and executed in real time by a browser application of the user electronic device 400. Particularly, the script for the advertisement of the present disclosure, which is a program included in advertisement contents, is executed by the user electronic device 400 and collects script information. The script information includes function execution selection information about an application set by a user input. The phrase “function execution selection information about an application” may be shortened to “selection information” for easier reading of the disclosure. Further, when user information associated with the user electronic device 400 is absent in the store server 200, the user information may be further collected by the script for the advertisement as the script information. The user information is unique information about the user electronic device 400, and may be at least one of an identification number, such as a Serial Number (S/N), an International Mobile Equipment Identify (IMEI), a Universally Unique Identifier (UUID), and a terminal number.

The selection information, which is information set by a user input, may mean that the user electronic device 400 selects a function to be executed in the user electronic device 400 in advance of a release date of the application, and the selection information may also be used to reserve the application in the store server 200. The selection information may include at least one of information about a selection of a function execution to automatically download and install an application, information about a selection of a function for executing a pop-up notification that notifies of a release of an application, and information about a selection of a function execution to display information about the released application.

The data associated with the registration of the application transmitted by the store server 200 to the user electronic device 400 may be at least one of installation data for installing an application in the user electronic device 400 and notification data for transmitting a notification of a release of an application to the user electronic device 400.

When the selection information stored as script information corresponds to a selection of a function to automatically install the application, the store server 200 may transmit installation data to the corresponding user electronic device 400 at the registration time of the application. The installation data includes an application installation file.

The notification data may be set as first notification data, second notification data, and third notification data according to a notification method to be executed by the user electronic device 400. When the selection information stored as script information corresponds to displaying information about the application on the recommendation tap, the store server 200 may transmit the first notification data to the user electronic device 400. The recommendation tap may be a display included in an executing screen of an application of a client of the store server. The recommendation tap displays when the user electronic device 400 is connected to the store server.

Otherwise, when the selection information stored as script information corresponds to execute a pop-up notification of a release of an application, the store server 200 may transmit the second notification data to the user electronic device 400. Here, the pop-up notification corresponds to a notification displayed on an execution screen of an application of a client of the store server.

Otherwise, when the selection information stored as the script information corresponds to executing a pop-up notification of a release of an application, the store server 200 may transmit the third notification data to the user electronic device 400. Here, the pop-up notification corresponds to a notification displayed on an idle screen and an execution screen of an application of the user electronic device 400.

The advertisement providing device 300 posts the advertisement contents transmitted from the seller electronic device 100 through a medium, such as the Internet. The advertisement contents may be provided to the user electronic device 400 through a banner advertisement, a web page, and the like.

The user electronic device 400 is a target contacting an advertisement and using an application, and is meant as an electronic device of a general user. The user electronic device 400 displays the advertisement contents containing the script for the advertisement, and detects a user input regarding the advertisement contents. When the user input is detected, the user electronic device 400 executes the script for the advertisement and collects script information through the script for the advertisement. Further, the collected script information is transmitted to the store server 200. Then, the user electronic device 400 may receive the installation data or the notification data transmitted from the store server 200 in response to the registration of the application.

The advertisement contents may be provided to the user electronic device 400 through, for example, an advertisement banner displayed on a web page.

The user electronic device 400 according to an exemplary embodiment of the present disclosure may set a function execution selection for the application according to the user input generated for the advertisement contents containing the script for the advertisement. The set selection information may be collected by the script for the advertisement as script information.

The function execution selection information about the application may be at least one of several things. It could be, for example, information about a function execution selection to automatically download and install an application in the user electronic device 400 according to the installation data received from the store server 200. Or it could be information about a selection of a function for executing a pop-up notification that notifies of release of an application according to the notification data received from the store server 200. Or it could be information about a function execution selection to display information about the released application on a recommendation tap according to the notification data received from the store server 200.

The script for the advertisement is executed according to generation of the user input for the advertisement contents, and the selection information may be collected as script information by the executing script for the advertisement. When user information associated with the user electronic device 400 is absent in the store server 200, the script for the advertisement may further collect user information associated with the user electronic device 400 as the script information. The user electronic device 400 transmits the collected script information to the store server 200.

The present disclosure may allow the user electronic device 400 to make a reservation for the application in advance of the release date. Accordingly, a selection may be made for a function related to the application to be executed later at the release time of the application, and this selection information may be transmitted to the store server 200.

When the set selection information according to the user input corresponds to automatically downloading and installing the application, the user electronic device 400 may receive installation data from the store server 200 at the registration time of the application. The installation data may include an application installation file.

When the set function selection information about the application according to the user input corresponds to notifying a release of the application, the user electronic device 400 may receive at least one of the first notification data, the second notification data, and the third notification data from the store server 200 according to a notification method to be executed by the user electronic device 400.

When the selection information set by the user input corresponds to displaying the information about the application on the recommendation tap, the user electronic device 400 may receive the first notification data from the store server 200. Here, the recommendation tap may be included in an execution screen of an application of a client of the store server.

Otherwise, when the selection information set by the user input corresponds to the selection of the function of executing the pop-up notification that notifies of the release of the application, the user electronic device 400 may receive the second notification data from the store server 200. Here, the pop-up notification corresponds to a notification displayed on an execution screen of an application of a client of the store server.

Otherwise, when the selection information set by the user input corresponds to the selection of the function of executing the pop-up notification that notifies of the release of the application, the user electronic device 400 may receive the third notification data from the store server 200. Here, the pop-up notification corresponds to a notification displayed on an idle screen and an execution screen of an application of the user electronic device 400.

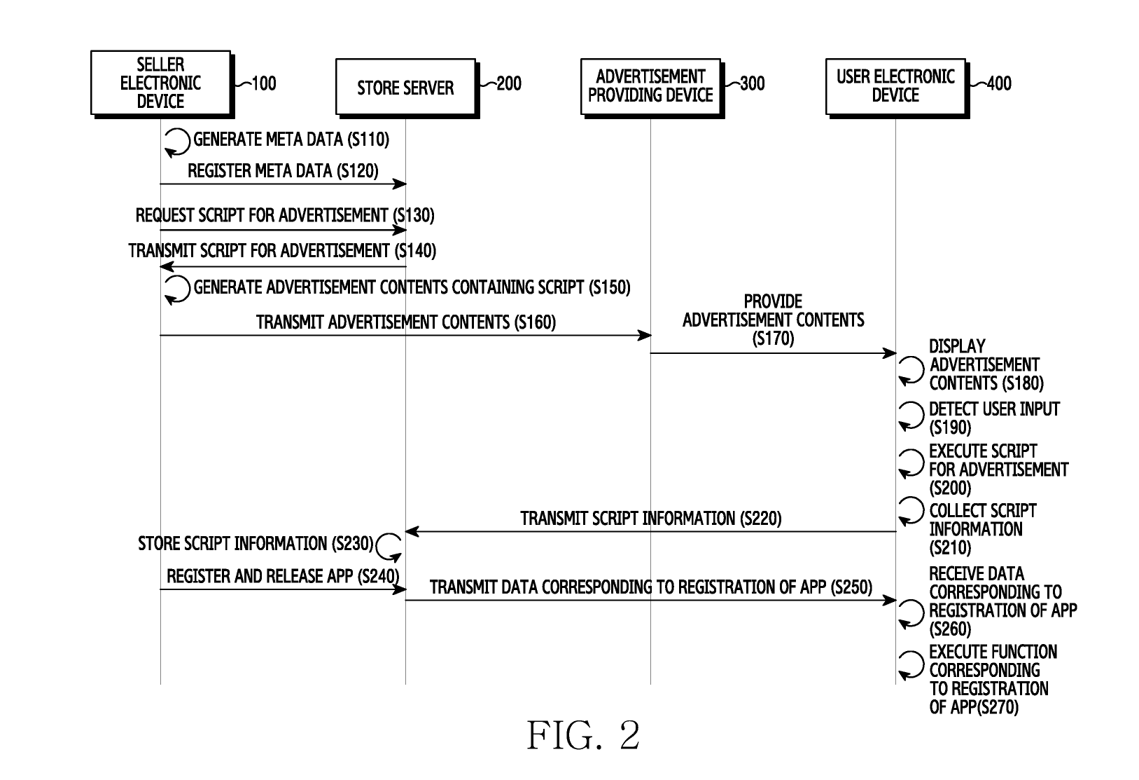

FIG. 2 is a data flow diagram describing a method of executing a function of an application based on an advertisement according to an exemplary embodiment of the present disclosure.

In operation S110, the seller electronic device 100 generates meta data of an application that is a target for production. The meta data may include a name of an application, a package name (unique ID) of an application, a project name, a producing company name, the kind of application, and the like.

In operations S120 and S130, the seller electronic device 100 registers the generated meta data in the store server 200, and requests an issue of a script for an advertisement. The script for the advertisement may be implemented using an interpreted programming language such that the script may be interpreted and executed in real time by a browser application of the user electronic device 400. Accordingly, the script need not be compiled. The script for the advertisement of the present disclosure, which is a program included in advertisement contents, is executed by the user electronic device 400 and collects script information. That is, the script for the advertisement is executed according to a user input generated for the advertisement contents and thus collects script information.

In this case, the script may collect as the script information various function selection information about the application that has been set by the user input. When user information associated with the user electronic device 400 is absent in the store server 200, the script for the advertisement may further collect the user information as the script information. The user information is unique information about the user electronic device 400, and may be at least one of an identification number, such as a Serial Number (S/N), an International Mobile Equipment Identify (IMEI), a Universally Unique Identifier (UUID), or a terminal number.

In operation S140, the store server 200 receiving the request of the issue of the script for the advertisement from the seller electronic device 100 transmits the script for the advertisement to the seller electronic device 100.

In operations S150 and S160, the seller electronic device 100 produces advertisement contents containing the script issued by the store server 200, and provides the produced advertisement contents to the advertisement providing device 300.

In operation S170, the advertisement providing device 300 provides the user electronic device 400 with the advertisement contents containing the script. For example, the advertisement providing device 300 may provide the advertisement contents through an execution screen of a web page or another application, an advertisement banner, and the like.

In operation S180, the user electronic device 400 displays the advertisement contents. For example, when a link (for example, Uniform Resource Locator (URL)) to a specific service is in the advertisement, the user electronic device 400 may use a browser to access the corresponding web page via the link. Accordingly, the advertisement contents can be displayed on the user electronic device 400.

In operation S190, the user electronic device 400 detects a user input for the advertisement. The user input is to select execution of a function of the application. Some functions may be to automatically download and install an application, a pop-up notification that notifies of a new release of the application, and display information about the released application. One or more of the functions may be selected by the user. The user's selection may be via a click, a double click, or a click and drag of an icon. The selections to be chosen from may each have corresponding button displayed on a screen, or an input window where the user can input characters.

In operation S200, the user electronic device 400 executes the script for the advertisement according to the user's input. In operation S210, the user electronic device 400 collects as script information the user entered selection information. When user information associated with the user electronic device 400 is absent in the store server 200, the script for the advertisement may further collect user information as script information.

In operation S220, the user electronic device 400 transmits the script information to the store server 200. In this case, the script may transmit the script information to the store server 200 by using a communication interface of the user electronic device 400.

In operation S230, the store server 200 stores the received script information in a database. The store server 200 may map the selection information that has been set by user input with corresponding user information. Furthermore, the store server 200 may map data information, which is to be transmitted to the user electronic device 400 when the application is registered and released at a later date, to the selection information.

When the selection information, which is stored as script information, corresponds to the selection of automatically installing an application, the store server 200 maps installation data to the selection information. The installation data includes an application installation file.

The notification data may be set as first notification data, second notification data, and third notification data according to a notification method to be executed by the user electronic device 400.

When the selection information stored as the script information corresponds to the selection of the function of displaying information about the application on the recommendation tap, the store server 200 may map the first notification data to the selection information. Here, the recommendation tap may be included in an execution screen of an application of a client of the store server.

Otherwise, when the selection information stored as script information corresponds to the selection of the function of executing a pop-up notification that notifies of a release of the application, the store server 200 may map the second notification data to the selection information and store the selection information. Here, the pop-up notification may correspond to a notification displayed on an execution screen of an application of a client of the store server.

Otherwise, when the selection information stored as the script information corresponds to the selection of the function of executing a pop-up notification that notifies of a release of the application, the store server 200 may map the third notification data to the selection information and stores the selection information. Here, the pop-up notification corresponds to a notification displayed on an idle screen and an execution screen of an application of the user electronic device 400.

In operation S240, when the seller electronic device 100 completely produces the application, the seller electronic device 100 registers the completed application in the store server 200 and releases the application.

In operation S250, when the registration of the application is confirmed, the store server 200 transmits data associated with the registration of the application to the user electronic device 400 based on the script information. The data associated with the registration of the application may be one of installation data for installing the application in the user electronic device 400 and notification data notifying the release of the application. The data transmitted to the user electronic device 400 according to the confirmation of the registration of the application may be data predetermined according to the selection information in operation S230. That is, when the selection information stored as the script information corresponds to the selection of the function of automatically installing the application, the store server 200 may transmit the installation data to the corresponding user electronic device 400 at the registration time of the application. The installation data includes an application installation file. The notification data may be set as first notification data, second notification data, and third notification data according to a notification method to be executed by the user electronic device 400.

Particularly, when the selection information stored as the script information corresponds to a selection of a function to display information about the application on the recommendation tap, the store server 200 may transmit the first notification data to the user electronic device 400. Here, the recommendation tap may be included in an execution screen of an application of a client of the store server.

Otherwise, when the selection information stored as the script information corresponds to a selection of a function to execute a pop-up notification that notifies of a release of an application, the store server 200 may transmit the second notification data to the user electronic device 400. Here, the pop-up notification corresponds to a notification displayed on an execution screen of an application of a client of the store server.

Otherwise, when the selection information stored as the script information corresponds to a selection of a function to execute a pop-up notification that notifies of a release of an application, the store server 200 may transmit the third notification data to the user electronic device 400. Here, the pop-up notification corresponds to a notification displayed on an idle screen and an execution screen of an application of the user electronic device 400.

In operation S260, the user electronic device 400 receives the data associated with the registration of the application from the store server 200. That is, the user electronic device 400 receives the installation data or the notification data according to the selection information stored as the script information.

In operation S270, the user electronic device 400 executes the function of the application according to the data associated with the registration of the application received from the store server 200. That is, when the user electronic device 400 receives the installation data from the store server 200, the user electronic device 400 downloads and installs the corresponding application.

Otherwise, when the user electronic device 400 receives the first notification data, the user electronic device 400 displays the information associated with the registration of the corresponding application through the recommendation tap in the execution screen of an application of a client of the store server 200.

Otherwise, when the user electronic device 400 receives the second notification data, the user electronic device 400 displays the information associated with the registration of the corresponding application through a pop-up window in the execution screen of an application of a client of the store server 200.

Otherwise, when the user electronic device 400 receives the third notification data, the user electronic device 400 displays the information associated with the registration of the corresponding application through a pop-up window on a screen, such as an idle screen or an execution screen.

According to a method of executing a function of an application based on advertisement according to various embodiments of the present disclosure, a user may set up, during an advertising stage of the product (application) before the release of the application, execution of a function related to the application at a later time. The user may make selections to automatically execute specific acts to get the application when it is released later. Accordingly, a product purchase probability at the time of the release of the product may be increased from the advertising stage before the release of the product, thereby improving the effectiveness of the entire advertising program for the application. Further, the user may conveniently receive information about a product of interest and buy the product of interest.

These are just some embodiments of notification display. Various embodiments of the present disclosure may display the notifications in different ways.

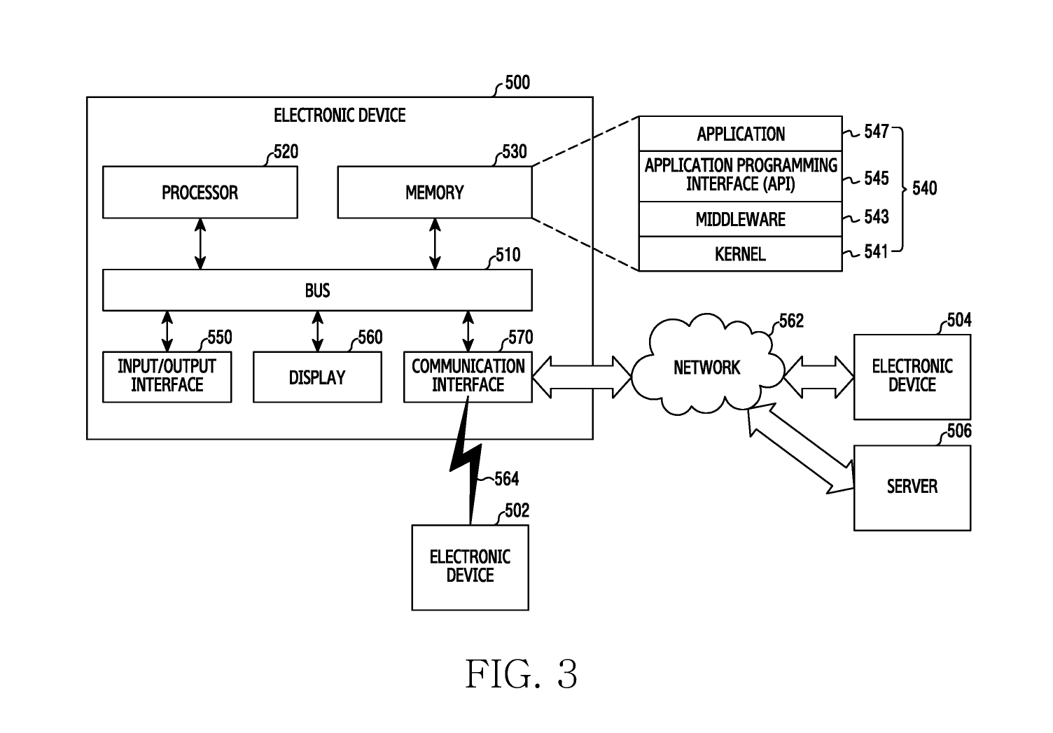

FIG. 3 is a block diagram of an electronic device according to an exemplary embodiment of the present disclosure.

Referring to FIG. 3, an electronic device 500 may include a bus 510, a processor 520, a memory 530, an input/output interface 550, a display 560, and a communication interface 570. According to various exemplary embodiments of the present disclosure, the electronic device 500 may have, at least one element omitted or another element may be additionally included.

The bus 510 may be a circuit for connecting devices such as, for example, the processor 520, the memory 530, the input/output interface 550, the display 560, or the communication interface 570), and transmitting communication (for example, a control message) between the devices.

The processor 520 may include one or more of a Central Processing Unit (CPU), an Application Processor (AP), and a Communication Processor (CP). The processor 520, for example, may carry out operations or data processing relating to the control and/or communication of one or more other elements of the electronic device 500.

The memory 530 may include a volatile memory and/or a non-volatile memory. The memory 530 may store a command or data (for example, a reception control list) associated with one or more other elements of the electronic device 500. According to an exemplary embodiment, the memory 530 may store software and/or a program 540. For example, the program 540 may include a kernel 541, a middleware 543, an Application Programming Interface (API) 545, or application programs 547. At least a part of the kernel 541, the middleware 543, and the API 545 may be referred to as an Operating System (OS).

The kernel 541 may control or manage system resources such as, for example, the bus 510, the processor 520, and the memory 530 used for executing an operation or a function implemented in other programs such as, for example, the middleware 543, the API 545, and the application programs 547. The kernel 541 may provide an interface through which the middleware 543, the API 545, or the application programs 547 may access a separate element of the electronic device 500 and control or manage the system resources.

The middleware 543 may serve as an intermediary that allows the API 545 or the application programs 547 communicate with the kernel 541 to exchange data. The middleware 543 may respond to operation requests received from the application programs 547. The middleware 543 may respond to, for example, scheduling or load balancing requests by assigning priority for using the system resource of the electronic device 500 to at least one application program among the application programs 547.

The API 545 may include an interface or a function (for example, a command) for enabling the application programs 547 to control a function provided by the kernel 541 or the middleware 543. For example, the API 545 may include at least one function for file control, window control, image control, or character control.

The input/output interface 550 may serve as an interface that may transfer a command or data input from a user or another external device to the other element(s) of the electronic device 500. Also, the input/output interface 550 may output commands or data received from other element(s) of the electronic device 500 to the user or another external device.

The display 560 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 560, for example, may display various types of contents (for example, text, images, videos, icons, or symbols) for the user. The display 560 may include a touch screen and receive, for example, a touch, gesture, proximity, or hovering input by using an electronic pen or a user's body part.

The communication interface 570 may establish communication between the electronic device 500 and an external device such as, for example, an electronic device 502, an electronic device 504, or a server 506. For example, the communication interface 570 may be connected to a network 562 through wireless or wired communication to communicate with the external electronic device. For example, the wireless communication may include at least one of, for example, WiFi, Bluetooth (BT), Near Field Communication (NFC), a Bluetooth Low Energy (BLE), and a Global Positioning System (GPS) as a short range communication protocol. Additionally or alternatively, wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), and Global System for Mobile Communications (GSM) as a cellular communication protocol. Wired communication may include at least one of, for example, Universal Serial Bus (USB), High Definition Multimedia Interface (HDMI), RS-232, and Plain Old Telephone Service (POTS).

The network 562 may include at least one communication network such as, for example, a computer network (for example, a LAN or a WAN), the Internet, and a telephone network.

According to various exemplary embodiments of the present disclosure, the electronic device 500 may provide, for example, LTE service in a single wireless environment by using one or more modules functionally or physically separated from the processor 520.

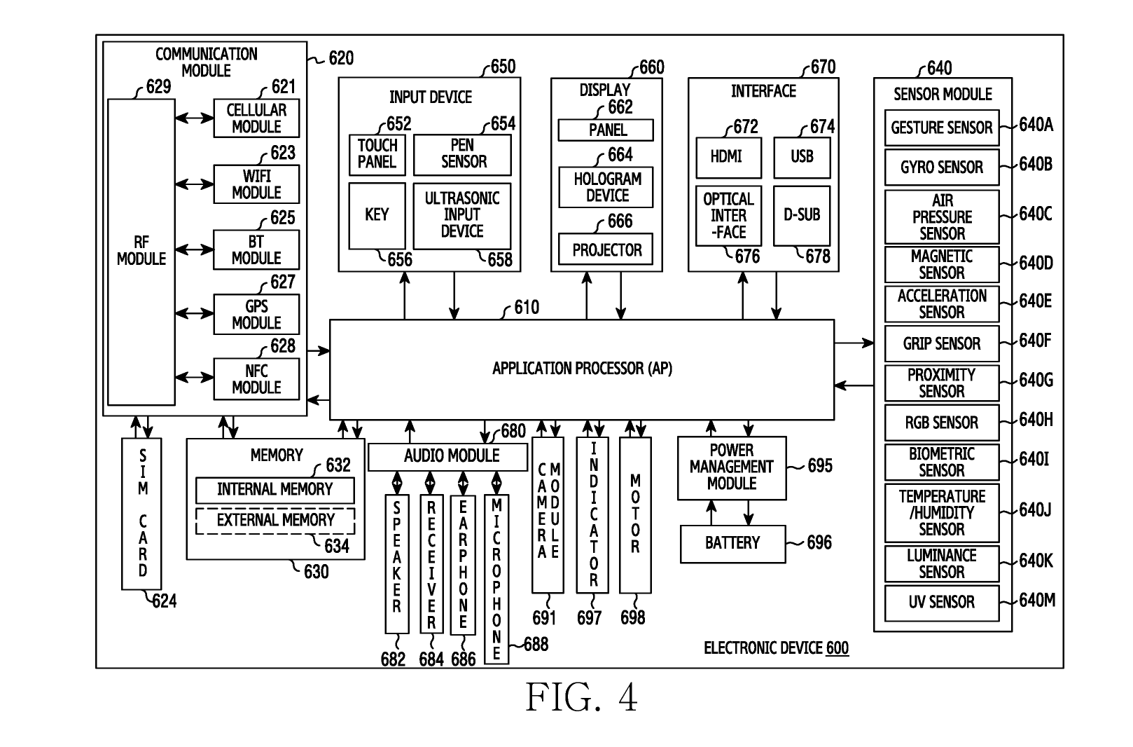

FIG. 4 is a block diagram of an electronic device according to an exemplary embodiment of the present disclosure. In the description below, an electronic device 600 may configure the entirety or a part of the electronic device 500 illustrated in FIG. 3.

Referring to FIG. 4, the electronic device 600 may include at least one application processor (AP) 610, a communication module 620, a subscriber identification module (SIM) card 624, a memory 630, a sensor module 640, an input module 650, a display 660, an interface 670, an audio module 680, an image sensor module 691, a power management module 695, a battery 696, an indicator 697, and a motor 698.

The AP 610 may use an operation system or an application program stored in the memory 630 to control a plurality of hardware or software components connected to the AP 610, and may perform processing or operation of various data including multimedia data. The AP 610 may be implemented by, for example, a System on Chip (SoC). According to an exemplary embodiment, the AP 610 may further include a graphic processing unit (GPU) (not shown).

The communication module 620 (for example, the communication interface 570) may perform data transception in communication with other electronic devices connected with the electronic device 600 (for example, the electronic device 500) through a network. According to one exemplary embodiment, the communication module 620 may include a cellular module 621, a WiFi module 623, a BT module 625, a GPS module 627, an NFC module 628, and a Radio Frequency (RF) module 629.

The cellular module 621 may provide a voice call, a video call, a short message service (SMS), or an Internet service through a communication network such as, for example, LTE, LTE-A, CDMA, WCDMA, UMTS, WiBro, or GSM. Further, the cellular module 621 may distinguish between and authenticate electronic devices in a communication network using, for example, a subscriber identification module (for example, the SIM card 624). According to an exemplary embodiment, the cellular module 621 may perform at least some of the functions that the AP 610 may provide. For example, the cellular module 621 may perform at least some of the multimedia control functions.

According to an exemplary embodiment, the cellular module 621 may include a Communication Processor (CP). Further, the cellular module 621 may be implemented by, for example, a SoC. Although components such as the cellular module 621, the memory 630, or the power management module 695 are illustrated as elements separated from the AP 610, according to various exemplary embodiments, the AP 610 may include at least some of the above described elements such as, for example, the cellular module 621.

According to an exemplary embodiment, the AP 610 or the cellular module 621 may load instructions or data received from at least one other component, for example, a non-volatile memory and other elements connected thereto to volatile memory and process the loaded instruction or data, and may store various types of data in, for example, the memory 630. For example, each of the WiFi module 623, the BT module 625, the GPS module 627, and the NFC module 628 may include a processor for processing data transmitted/received through the corresponding module. Although each of the cellular module 621, the WiFi module 623, the BT module 625, the GPS module 627, and the NFC module 628 is shown as a separate block in FIG. 4, two or more of the cellular module 621, the WiFi module 623, the BT module 625, the GPS module 627, and the NFC module 628 may be included in one integrated chip (IC) or IC package according to various embodiments of the present disclosure. For example, at least some processors corresponding to the cellular module 621, the WiFi module 623, the BT module 625, the GPS module 627, and the NFC module 628 may be implemented as one SoC.

The RF module 629 may transmit and receive RF signals. The RF module 629 may include, for example, a transceiver, a Power Amp Module (PAM), a frequency filter, a Low Noise Amplifier (LNA), or the like that are not illustrated. Although the cellular module 621, the WiFi module 623, the BT module 625, the GPS module 627, and the NFC module 628 are illustrated to share one RF module 629 in FIG. 4, at least one of the cellular module 621, the WiFi module 623, the BT module 625, the GPS module 627, and the NFC module 628 may transmit/receive RF signals through a separate RF module.

According to an exemplary embodiment, the RF module 629 may include at least one antenna between a main antenna and a sub antenna functionally connected with the electronic device 600. The communication module 620 may support Multiple Input Multiple Output (MIMO) capacity by using the main antenna and the sub antenna.

The SIM card 624 may be a card containing subscriber identification module and may be inserted into a slot formed in a specific position of the electronic device. The SIM card 624 may include unique identification information such as, for example, an integrated circuit card identifier (ICCID), or unique subscriber information such as, for example, an international mobile subscriber identity (IMSI).

The memory 630 may include an internal memory 632 and/or an external memory 634. The internal memory 632 may include at least one of volatile memory such as, for example, Dynamic Random Access Memory (DRAM), Static RAM (SRAM), Synchronous Dynamic RAM (SDRAM), and the like, and non-volatile memory such as, for example, One Time Programmable Read Only Memory (OTPROM), Programmable ROM (PROM), Erasable and Programmable ROM (EPROM), Electrically Erasable and Programmable ROM (EEPROM), mask ROM, flash ROM, and the like).

According to an exemplary embodiment, the internal memory 632 may be a solid state drive (SSD). The external memory 634 may further include a flash drive, for example, a compact flash (CF), a secure digital (SD), a micro secure digital (Micro-SD), a mini secure digital (Mini-SD), an extreme digital (xD), a Memory Stick, or the like. The external memory 634 may be functionally connected to the electronic device 600 through various interfaces. According to an exemplary embodiment, the electronic device 600 may further include a storage device (or storage medium), such as a hard disc drive.

The sensor module 640 may measure a physical quantity or sense an operational state of the electronic device 600 and convert the measured or sensed information into an electric signal. The sensor module 640 may include at least one of, for example, a gesture sensor 640A, a gyro sensor 640B, an atmospheric pressure sensor 640C, a magnetic sensor 640D, an acceleration sensor 640E, a grip sensor 640F, a proximity sensor 640G, a color sensor 640H (for example, a Red/Green/Blue (RGB) sensor), a biometric sensor 640I, a temperature/humidity sensor 640J, an illumination sensor 640K, and an Ultra Violet (UV) sensor 640M. Additionally, or alternatively, the sensor module 640 may include, for example, an E-nose sensor (not shown), an electromyography (EMG) sensor (not shown), an electroencephalogram (EEG) sensor (not shown), an electrocardiogram (ECG) sensor (not shown), an Infrared (IR) sensor (not shown), an iris sensor (not shown), a fingerprint sensor (not shown), and the like. The sensor module 640 may further include a control circuit for controlling one or more sensors included therein.

The input module 650 may include a touch panel 652, a (digital) pen sensor 654, a key 656, or an ultrasonic input device 658. The touch panel 652 may use at least one of, for example, a capacitive type technology, a resistive type technology, an infrared type technology, and an acoustic wave type technology. Also, the touch panel 652 may further include a control circuit. A capacitive touch panel may recognize a physical contact or proximity. The touch panel 652 may further include a tactile layer. In this case, the touch panel 652 may provide a user with a tactile reaction.

The (digital) pen sensor 654 may be implemented, for example, using a method identical or similar to a method of receiving a touch input of a user, or using a separate recognition sheet. The key 656 may include, for example, a physical button, an optical key, or a keypad. The ultrasonic input device 658 is a device which is capable of identifying data by generating an ultrasonic signal through an input tool and detecting a sonic wave through a microphone (for example, the microphone 688) in the electronic device 600, and is capable of wireless recognition. According to an exemplary embodiment, the electronic device 600 may also receive a user input from an external device (for example, a computer or a server) connected via the communication module 620.

The display 660, which may be similar to the display 560, may include a panel 662, a hologram electronic device 664, or a projector 666. For example, the panel 662 may use, for example, a Liquid Crystal Display (LCD) technology, an Active Matrix Organic Light Emitting Diode (AM-OLED) technology, or the like. The panel 662 may be implemented to be, for example, flexible, transparent, or wearable. The panel 662 and the touch panel 652 may be implemented as one module. The hologram electronic device 664 may show a stereoscopic image in the air by using interference of light. The projector 666 may display an image by projecting light onto a screen. The screen may be located, for example, inside or outside the electronic device 600. According to an exemplary embodiment, the display 660 may further include a control circuit for controlling the panel 662, the hologram electronic device 664, or the projector 666.

The interface 670 may support, for example, a High-Definition Multimedia Interface (HDMI) 672, a Universal Serial Bus (USB) 674, an optical interface 676, and a D-subminiature (D-sub) interface 678. Additionally or alternatively, the interface 670 may, for example, include a mobile high-definition link (MHL) interface, a secure digital card/multi-media card (SD/MMC) interface, or an infrared data association (IrDA) interface.

The audio module 680 may convert sound to electrical signals and vice versa. The audio module 680 may process sound information which is input through, for example, a receiver 684, the microphone 688, or the like, and output through, for example, a speaker 682, an earphone 686, or the like.

The camera module 691 may capture, for example, a still image or video and, according to an embodiment of the present disclosure, may include one or more image sensors such as, for example, a front sensor or a back sensor, a lens, an Image Signal Processor (ISP), or a flash (e.g., an LED or a xenon lamp).

The power management module 695 may manage the power of the electronic device 600. Although not illustrated, the power management module 695 may include, for example, a Power Management Integrated Circuit (PMIC), a charger Integrated Circuit (IC), or a battery or fuel gauge. The PMIC may be mounted within, for example, an integrated circuit or a SoC semiconductor. Charging methods may be classified into a wired charging method and a wireless charging method. The charger IC may charge a battery and may prevent an overvoltage or excess current from being induced or flowing from a charger. According to an exemplary embodiment, the charger IC may include a charger IC for at least one of the wired charging and the wireless charging. Examples of the wireless charging may include magnetic resonance charging, magnetic induction charging, and electromagnetic charging, and an additional circuit such as a coil loop, a resonance circuit, and a rectifier may be added for the wireless charging.

The battery gauge may measure, for example, a remaining charge of the battery 696, and voltage, current, or temperature during charging. The battery 696 may store or generate electricity and may supply power to the electronic device 600 by using the stored or generated electricity. The battery 696 may include, for example, a rechargeable battery or a solar battery.

The indicator 697 may display a specific state, such as a booting state, a message state, a charging state, of the electronic device 600 or a part of the electronic device 600 (for example, the AP 610). The motor 698 may convert an electrical signal into a mechanical vibration, and may generate a vibration or haptic effect. Although not illustrated, the electronic device 600 may include a processing unit such as a GPU that may support, for example, mobile television (TV). The processing unit for supporting mobile TV may process media data transmitted using standards such as Digital Multimedia Broadcasting (DMB), Digital Video Broadcasting (DVB), media flow, etc.

Each of the above described elements of the electronic device according to various embodiments of the present disclosure may be formed of one or more components, and the name of a corresponding element may vary according to the type of an electronic device. The electronic device according to various embodiments of the present disclosure may include at least one of the above described elements, and may exclude some of the elements or further include other additional elements. Further, some of the elements of the electronic device according to various embodiments of the present disclosure may be coupled to form a single entity while performing the same functions as those of the corresponding elements before the coupling.

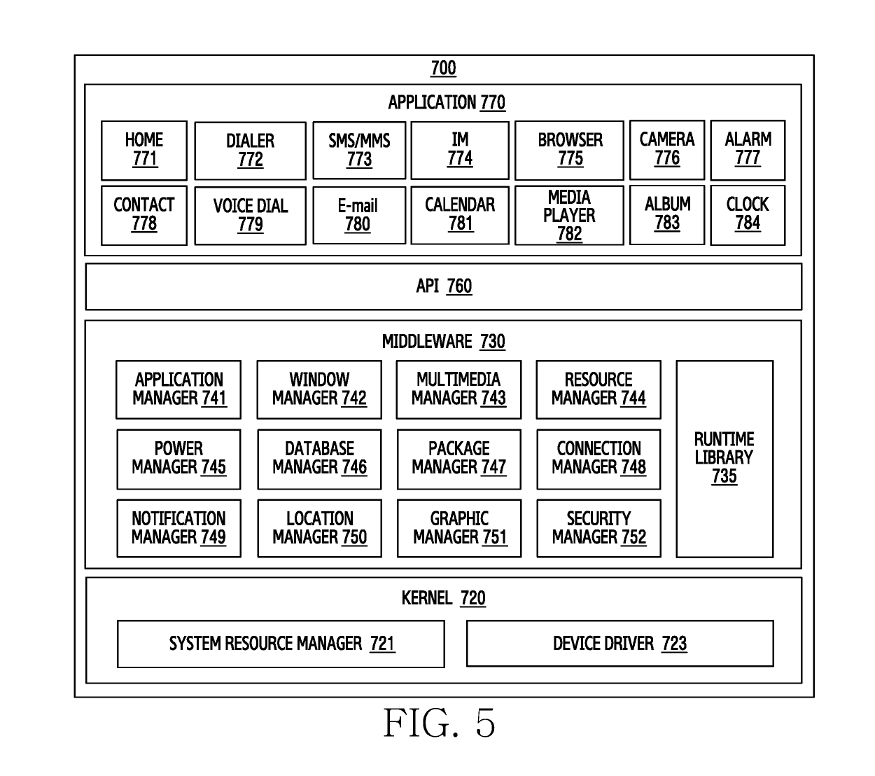

FIG. 5 is a block diagram illustrating a program module according to various exemplary embodiments of the present disclosure.

The program module 700 may include a kernel 720, middleware 730, an Application Programming interface (API) 760, and/or applications 770. At least some of the program module 700 may be preloaded on the electronic device, or may be downloaded from an external electronic device such as, for example, the electronic devices 502 or 504, or the server 506.

The kernel 720, which may be similar to kernel 541, may include, for example, a system resource manager 721 and/or a device driver 723. The system resource manager 721 may perform the control, allocation, retrieval, or the like of system resources. According to one embodiment of the present disclosure, the system resource manager 721 may include a process management unit, a memory management unit, or a file system management unit. The device driver 723 may include, for example, a display driver, a camera driver, a Bluetooth driver, a shared memory driver, a USB driver, a keypad driver, a WiFi driver, an audio driver, or an Inter-Process Communication (IPC) driver.

The middleware 730, which may be similar to middleware 543, may provide a function required by the applications 770 in common or provide various functions to the applications 770 through the API 760 so that the applications 770 may efficiently use limited system resources within the electronic device. According to an exemplary embodiment, the middleware 730 may include, for example, at least one of a runtime library 735, an application manager 741, a window manager 742, a multimedia manager 743, a resource manager 744, a power manager 745, a database manager 746, a package manager 747, a connection manager 748, a notification manager 749, a location manager 750, a graphic manager 751, and a security manager 752.

The runtime library 735 may include a library module that a compiler uses in order to add a new function while the applications 770 are being executed. The runtime library 735 may perform input/output management, memory management, arithmetic functions, or the like.

The application manager 741 may manage, for example, a life cycle of at least one of the applications 770. The window manager 742 may manage Graphical User Interface (GUI) resources used for the screen. The multimedia manager 743 may determine a format required to reproduce various media files, and may encode or decode a media file by using a coder/decoder (codec) appropriate for the corresponding format. The resource manager 744 may manage resources, such as a source code, a memory, a storage space, and the like of at least one of the applications 770.

The power manager 745 may operate together with a Basic Input/Output System (BIOS) to manage a battery or power, and may provide power information required for the operation of the electronic device. The database manager 746 may generate, search for, and/or change a database to be used by at least one of the applications 770. The package manager 747 may manage the installation or update of an application distributed in the form of a package file.

The connection manager 748 may manage a wireless connection such as, for example, WiFi or Bluetooth. The notification manager 749 may display or notify of an event, such as an arrival message, an appointment, a proximity notification, and the like, in such a manner as not to disturb the user. The location manager 750 may manage location information of the electronic device. The graphic manager 751 may manage a graphic effect, which is to be provided to the user, or a user interface associated with the graphic effect. The security manager 752 may provide various security functions required for system security, user authentication, and the like. According to an exemplary embodiment of the present disclosure, when the electronic device (for example, the electronic device 500) has a telephone call function, the middleware 730 may further include a telephony manager for managing a voice call function or a video call function of the electronic device.

The middleware 730 may include a middleware module that forms a combination of various functions of the above-described elements. The middleware 730 may provide a module specialized for each type of OS in order to provide a differentiated function. Also, the middleware 730 may dynamically delete some of the existing elements, or may add new elements.

The API 760, which may be similar to API 545, is a set of API programming functions, and may be provided with a different configuration according to an OS. For example, in the case of Android or iOS, one API set may be provided for each platform. Other operating systems such as, for example, Tizen, may have two or more API sets for each platform.

The applications 770, which may be similar to application programs 547, may include, for example, one or more applications that can provide functions such as home 771, dialer 772, SMS/MMS 773, Instant Message (IM) 774, browser 775, camera 776, alarm 777, contacts 778, voice dialer 779, email 780, calendar 781, media player 782, album 783, and clock 784. Other applications programs may be health related (for example, measure heart rate, exercise duration, or blood sugar), or weather related (for example, atmospheric pressure, humidity, or temperature).

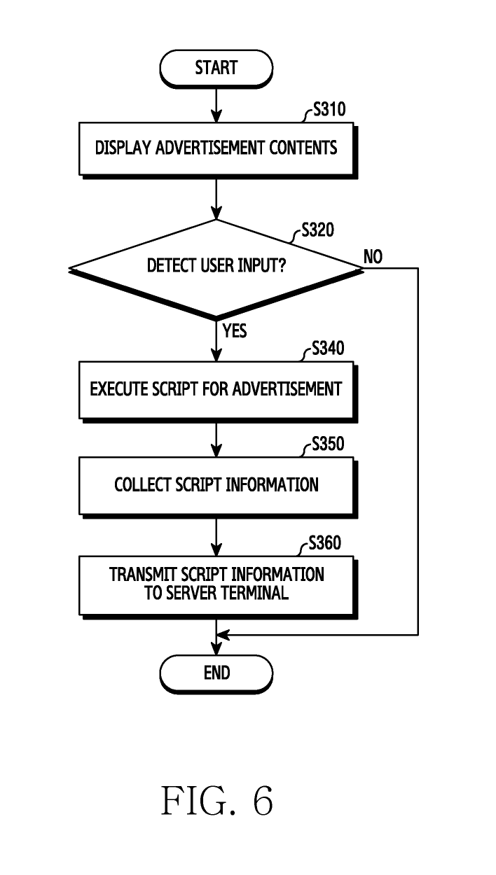

FIG. 6 is a flow chart describing a method of setting the execution a function for a registration of an application of a user electronic device according to an exemplary embodiment of the present disclosure.

As illustrated in FIG. 6, in operation S310 the user electronic device 400 displays advertisement provided by the advertisement providing device 300. The user electronic device 400 may display the advertisement through, for example, an advertisement banner on a portion of a screen, or on a web page. The advertisement may include a script, where the script is a program executed according to a user input. The script may collect script information that includes function execution information about registration of an application selected by the user. When user information associated with the user electronic device 400 is absent in the server 800, the script for the advertisement may further collect user information as script information. The user information is unique information about the user electronic device 400 and may be at least one of an identification number, a Serial Number (S/N), an International Mobile Equipment Identity (IMEI), a Universally Unique Identifier (UUID), and a terminal number. The script for the advertisement may be implemented by a programming language that can be interpreted and executed at run time by, for example, a browser on the user electronic device 400.

In operation S320, the user electronic device 400 detects the user input for the advertisement. The user electronic device 400 may then set a function execution selection according to the user input. The set function execution selection information (selection information) for the advertisement may be collected by the script as script information. The selection information may be at least one of the following where other pieces of information not listed may also be used: information about selection of automatically downloading and installing an application in the user electronic device 400 according to the installation data received from the server 800; information about selection of executing a pop-up notification that notifies of a release of an application according to the notification data received from the server 800; and information about selection of displaying information about the released application on a recommendation tap according to the notification data received from the server 800. For example, the user input may be set by a click, a double click, or a click and drag of an icon, for selecting the function execution associated with the release of the application displayed on the advertisement contents, or an input of a character(s) into an input window.

When the user input is detected in operation S320, the user electronic device 400 executes the script for the advertisement in operation S340. The executed script collects the selection information that has been set by the user input. When user information associated with the user electronic device 400 is absent in the server 800, the script for the advertisement may further collect user information associated with the user electronic device 400 as the script information. When the user input is not detected in operation S320, the user electronic device 400 ends the process.

In operation S350, the user electronic device 400 collects the script information through the execution of the script for the advertisement. The script information includes one or more elements of the selection information that has been set by user input.

In operation S360, the user electronic device 400 transmits the collected script information to the server 800. Accordingly, a user of the user electronic device 400 may select in advance a function related to the application to be executed later at a release time of the application, and that selection may be transmitted to the server 800.

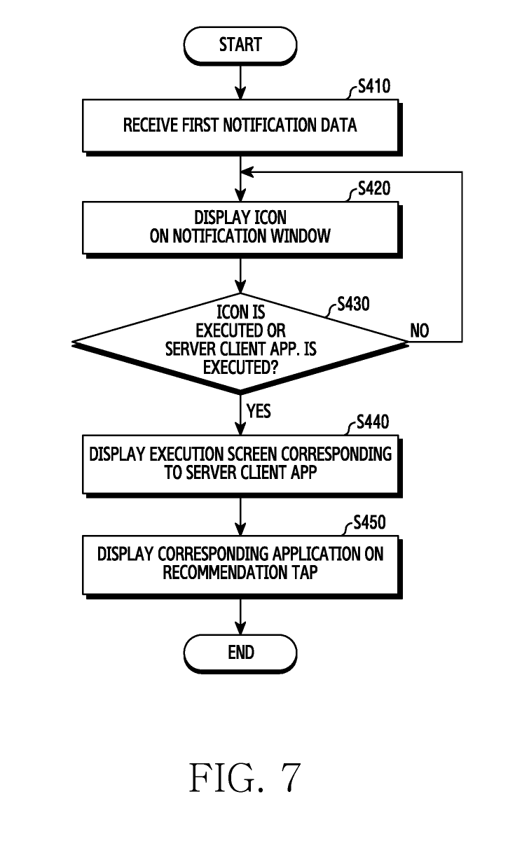

Hereinafter, FIGS. 7 to 10 are flow charts for describing a method of executing a function of a user electronic device for an application according to exemplary embodiment of the present disclosure.

Referring to FIG. 7, in operation S410, the user electronic device 400 receives the first notification data from the server 800. In operation S420, the user electronic device 400 displays an icon on a notification window based on the first notification data. The icon may represent reception of new data for an application of a client of the store server 200. When the icon is executed by a user, for example, by clicking on the icon, or the application of the client of the store server is executed in operation S430, the user electronic device 400 displays an execution screen associated with the application of the server client in operation S440. In operation S450, the user electronic device 400 displays the corresponding application on a recommendation tap of the execution screen. That is, the user electronic device 400 may notify a release of the corresponding application, and further display a selection screen for downloading and installing the corresponding application.

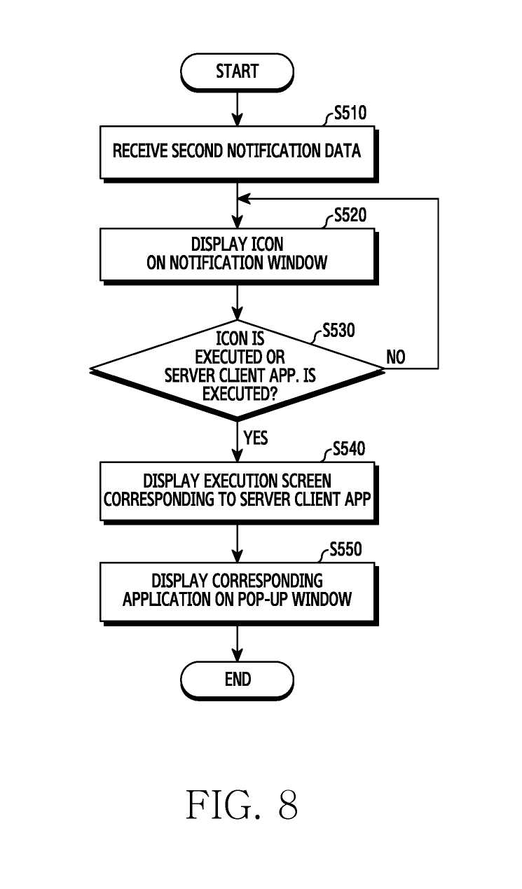

Referring to FIG. 8, in operation S510, the user electronic device 400 receives the second notification data from the server 800. In operation S520, the user electronic device 400 displays an icon on a notification window based on the second notification data. The icon may represent reception of new data associated with an application of a client of the store server. When the icon is executed by a user, or the application of the client of the store server is executed in operation S530, the user electronic device 400 displays an execution screen associated with the application of the server client in operation S540. Further, in operation S550, the user electronic device 400 displays the corresponding application through a pop-up window on the execution screen. That is, the user electronic device 400 may notify a release of the corresponding application through the pop-up window, and further display a pop-up window for downloading and installing the corresponding application.

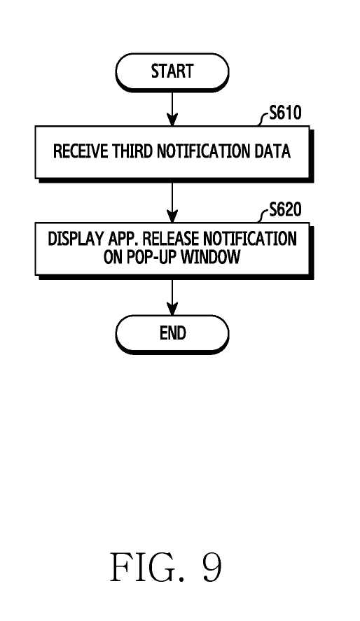

Referring to FIG. 9, in operation S610, the user electronic device 400 receives the third notification data from the server 800. In operation S620, the user electronic device 400 displays a pop-up window notifying the user of a released application on an idle screen or an execution screen of another application based on the third notification data.

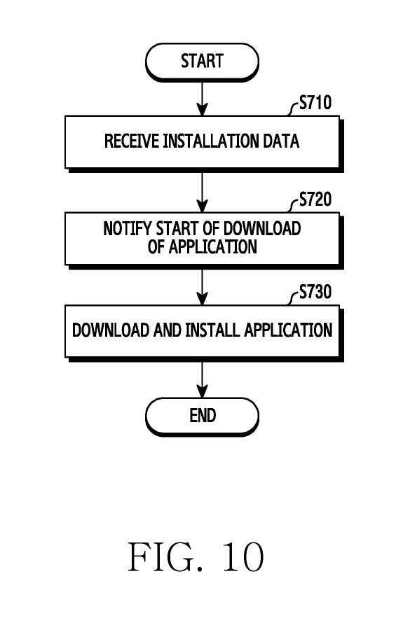

Referring to FIG. 10, in operation S710, the user electronic device 400 receives installation data from the server 800. In operation S720, the user electronic device 400 gives notification on the screen of start of a download of the application. In operation S730, the user electronic device 400 downloads and installs the application.

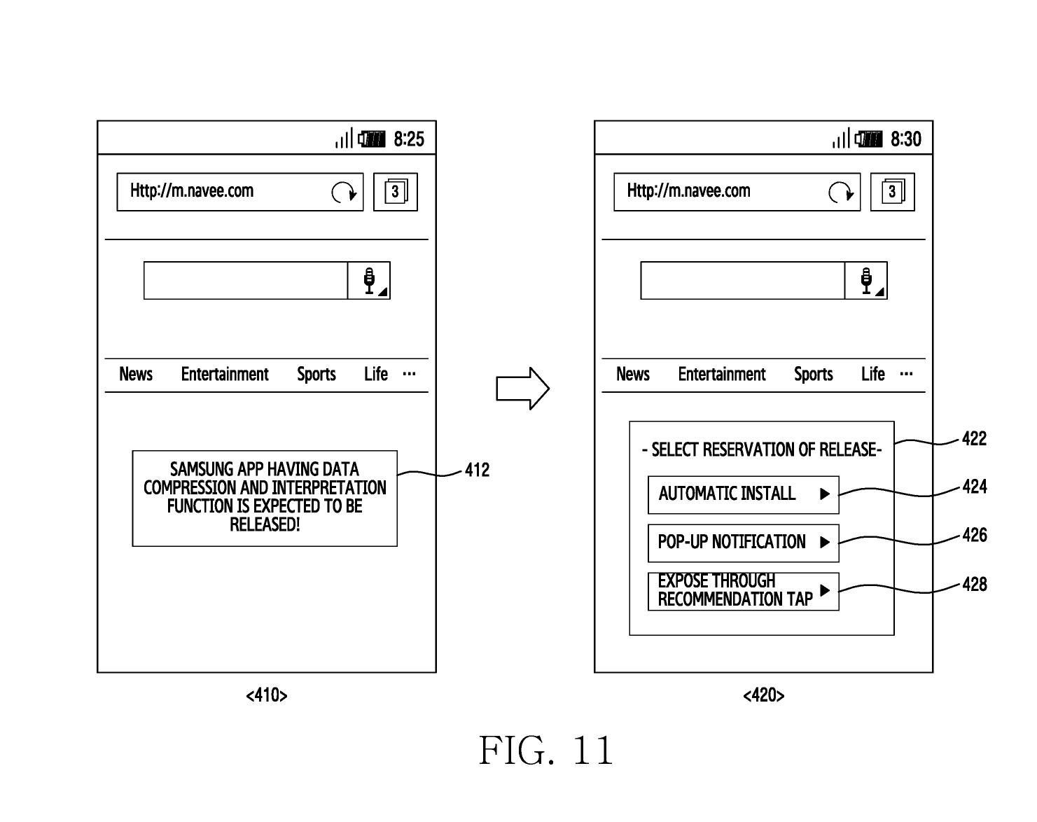

FIG. 11 is a diagram describing a method of execution of a function of an application based on an advertisement associated with an exemplary embodiment of the present disclosure.

As shown in an execution screen 410 illustrated in FIG. 11, the user electronic device 400 displays an advertisement banner 412 posted through a web page by the advertisement providing device 300 on a screen. Then, when a user of the user electronic device 400 accesses the advertisement banner 412, the advertisement contents 422 may be shown as in the execution screen 420. The advertisement contents 422 may alternatively be displayed in the form of a pop-up window.

The advertisement contents 422, comprising the various options 424, 426, and 428, may be displayed on the execution screen 420. The user may then, for example, make advance arrangements for a function associated with an application to be executed at a later release time of the application. That is, the advertisement contents 422 may include a user being able to select at least one of a function to automatically download and install the application, the function to provide a pop-up notification of release of the application, and the function to display information about the released application on a recommendation tap. When at least one function is selected by a user input, the information about the function execution selection for the application may be collected as script information through the execution of the script for the advertisement. Accordingly, various embodiments of the present disclosure may allow a selected function related to the application to be executed in the future by transmitting the collected script information to the store server 200 through a communication interface.

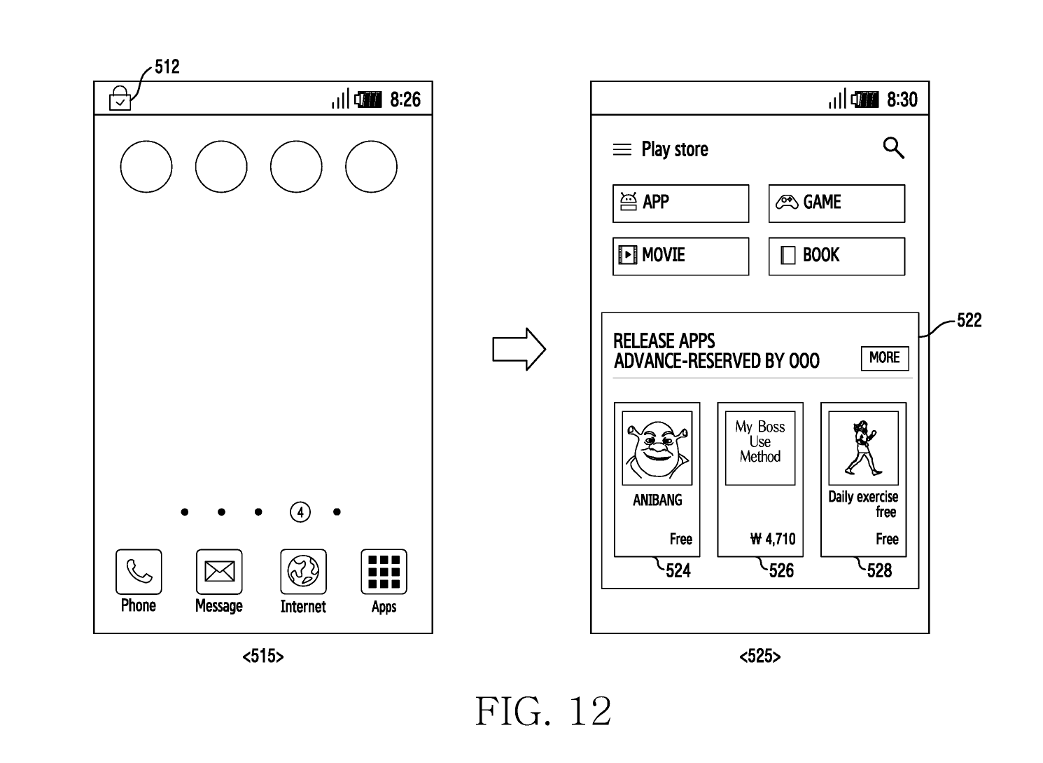

FIGS. 12 to 14 are diagrams describing a method of executing a function of an application based on an advertisement associated with an exemplary embodiment of the present disclosure.

Referring to FIG. 12, when the release time of the application arrives, the user electronic device 400 may receive notification data associated with the release of the application from the server 800. The user electronic device 400 may display an icon 512 notifying reception of new information associated with the application of the store client on a notification bar as shown in the execution screen 515.

When the icon 512 is executed by the user input, icons associated with the corresponding applications 524, 526, and 528 are exposed on a recommendation tap 522 of the execution screen 525 of the application of the server client. The applications exposed on the recommendation tap may be different applications 524, 526, and 528.

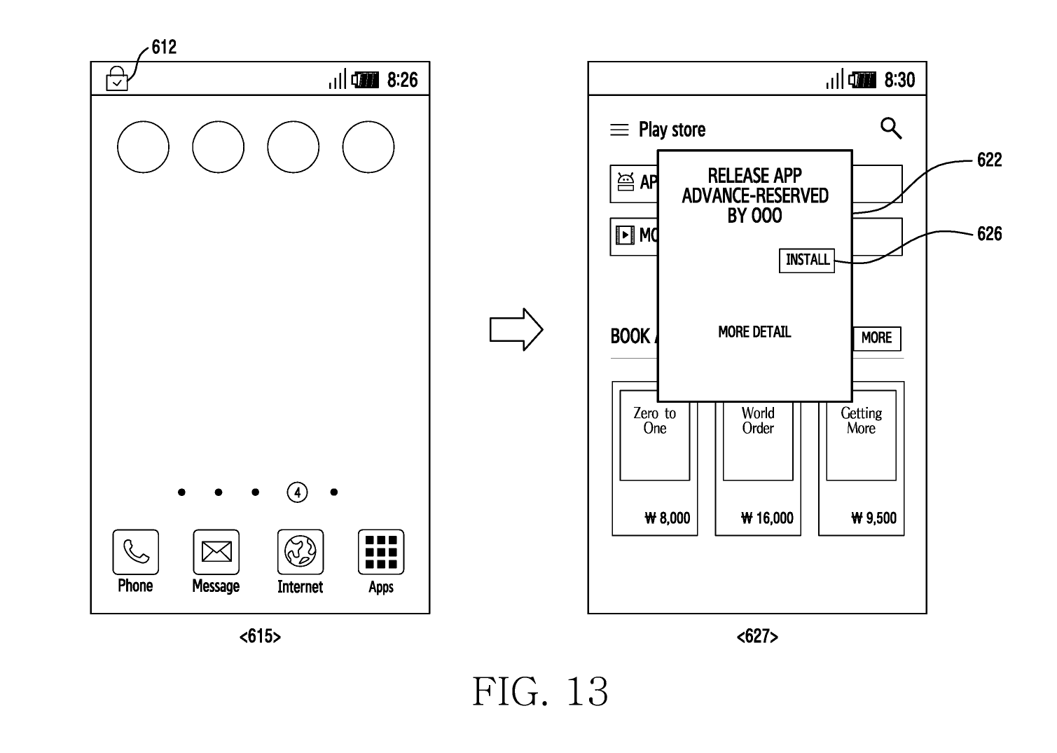

When the application is released as shown in the execution screen 615 of FIG. 13, the user electronic device 400 may receive notification data associated with the release of the corresponding application from the server 800. The user electronic device 400 may display an icon 612 giving notice of reception of new information associated with the application of the server client on a notification bar as shown in an execution screen 615. When the icon 612 is executed by the user input, a pop-up window 622 that notifies of the release of the corresponding application is displayed on an execution screen of the application of the store client as shown in an execution screen 617. Along with the contents giving notice of release of the application, the pop-up window 622 may display a selection button 626 for downloading and installing the application.

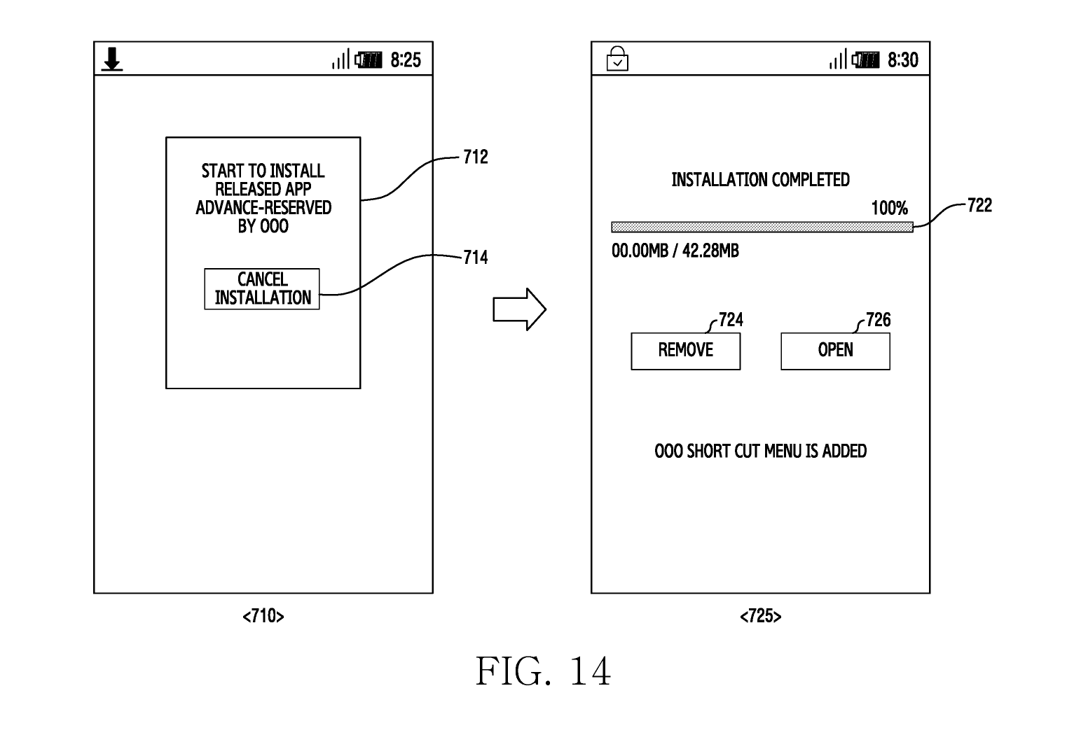

Referring to an execution screen 710 of FIG. 14, when the application is released, the user electronic device 400 receives installation data from the server 800, and the application is automatically downloaded and installed in the user electronic device 400 based on the received installation data. In this case, a pop-up window 712 giving notice of the automatic downloading and installation of the application may be displayed as shown in the execution screen 710. An execution screen 725 may be displayed subsequent to the display of the pop-up window 712, and a progress bar 722 showing the installation progress may be shown in the execution screen 725. An open button 724 that may be used to start execution of the installed application may be displayed after the completion of the installation.

According to a method of executing a function related to an application based on an advertisement according to an exemplary embodiment of the present disclosure, a user may make arrangements in advance for the execution a function related to an application. For example, the arrangements may be made during an advertising stage of the product (application) before the release of the application. When the product is released later, the function related to the application may be automatically executed. Accordingly, the probability of purchase of a product at the time of the release of the product may be increased due to actions taken to reserve the product during the advertising stage before the release of the product, thereby improving the effectiveness of the advertisement. Further, the user may conveniently receive information about a product of interest and buy the product of interest.

At least a part of a device (for example, modules or functions thereof) or a method (for example, operations) according to various embodiments of the present disclosure may be implemented with instructions stored in a computer-readable storage medium in the form of a program module. When an instruction is executed by a processor (for example, the processor 120), the one or more processors may perform a function corresponding to the instruction. The computer-readable storage medium may be, for example, the memory 130.

The computer readable recording medium includes, for example, magnetic media such as hard disk, floppy disk, or magnetic tape, optical media such as Compact Disc Read Only Memory (CD-ROM) or digital versatile disc (DVD), magneto-optical media such as floptical disk, and integrated circuit devices such as ROM, random access memory (RAM), and flash memory. The computer readable recording medium may be used to store program instructions and data. The program instructions may include machine language code created by a compiler and a high-level language code interpreted and executed by a computer using an interpreter. The foregoing hardware device may be configured to be operated as at least one software module to perform an operation of the present disclosure, or vice versa.

Modules or programming modules according to various embodiments of the present disclosure may include one or more of the foregoing elements, have some of the foregoing elements omitted, or further include additional other elements. Operations performed by the modules, the programming modules or other elements may be executed in a sequential, parallel, repetitive and/or heuristic manner. Also, some of the operations may be executed in different order or omitted, or may have additional different operations.

The embodiments disclosed herein have been provided for description and understanding of disclosed technical matters, and are not intended to limit the scope of the present disclosure. Therefore, it should be construed that the scope of the present disclosure includes any change or other various embodiments based on the technical spirit of the present disclosure.

What is claimed is:

1. A method, comprising:
displaying on an electronic device advertisement contents;
detecting at least one user input in response to the advertisement contents;
executing a script included in the advertisement contents based on the user input;
collecting script information according to the executed script;
receiving data associated with a registration of at least one application including a function corresponding to the script information; and
executing the function associated with the application based on the data.

2. The method of claim 1, wherein the data comprises at least one of: installation data for downloading and installing the application and notification data notifying of release of the application.

3. The method of claim 2, wherein executing the function comprises displaying a notification of the release of the application in a notification window of the electronic device if the notification data is received.

4. The method of claim 2, wherein executing the function comprises displaying information about the application in a recommendation tap of the electronic device if the notification data is received.

5. The method of claim 2, wherein executing the function comprises displaying a pop-up notification of the release of the application on the electronic device if the notification data is received.

6. The method of claim 2, wherein executing the function comprises displaying a notification of the release of the application in a notification window of the electronic device and downloading and installing the released application if the installation data is received.

7. The method of claim 1, wherein the script information comprises function execution selection information associated with the registration of the application by the user input.

8. The method of claim 1, wherein the script information comprises user information associated with the electronic device.

9. The method of claim 1, wherein the script information is transmitted to an external electronic device and the data is received from the external electronic device, and the data comprises registration information associated with the application.

10. An electronic device, comprising:
a display configured to display advertisement contents; and
a processor configured to detect at least one user input in response to the advertisement contents, to execute a script included in the advertisement contents based on the user input, to collect script information according to the executed script, to receive data associated with a registration of at least one application including a function corresponding to the script information, and to execute the function associated with the application based on the data.

11. The electronic device of claim 10, wherein the data comprises at least one of: installation data for downloading and installing the application and notification data notifying of release of the application.

12. The electronic device of claim 11, wherein the processor is configured to display a notification the release of the application in a notification window of the electronic device if the notification data is received.

13. The electronic device of claim 11, wherein the processor is configured to display information about the application in a recommendation tap in the display of the electronic device if the notification data is received.

14. The electronic device of claim 11, wherein the processor is configured to display a pop-up notification of the release of the application on the electronic device if the notification data is received.

15. The electronic device of claim 11, wherein the processor is configured to display a notification of the release of the application in a notification window of the electronic device and downloads and installs the released application if the installation data is received.

16. The electronic device of claim 10, wherein the script information comprises function execution selection information associated with the registration of the application by the user input.

17. The electronic device of claim 10, wherein the script information comprises user information associated with the electronic device.

18. The electronic device of claim 10, further comprising a communication interface configured to transmit the script information to an external electronic device and receive the data from the external electronic device, wherein the data comprises registration information associated with the application.

19. A server, comprising:
a sales unit configured to produce an application and advertisement contents for the application;
an advertisement providing unit configured to provide the advertisement contents containing a script for an advertisement; and
a store unit configured to receive script information collected by the script for the advertisement, register the application produced by the sales unit, and transmit data associated with the registration of the application to an electronic device according to the registration of the application.
